(19) United States
(12) Patent Application Publication
(10) Pub. No.: US 2026/0200393 A1
(43) Pub. Date: Jul. 16, 2026

(54) TENSIONING DEVICE

(71) Applicant: Bernard Kruseman, Middle Springs, NC (US)

(72) Inventor: Bernard Kruseman, Middle Springs, NC (US)

(21) Appl. No.: 19/434,281

(22) Filed: Dec. 29, 2025

Related U.S. Application Data
(60) Provisional application No. 63/742,469, filed on Jan. 7, 2025.

(51) Int. Cl. B60P 7/08

(52) U.S. Cl. CPC B60P 7/0838

(57) ABSTRACT

The present invention relates to an improved tensioning device that in at least one embodiment contains no moving parts. The present invention greatly simplifies the process of placing and maintaining a tow or cargo strap under tension with a single integral piece that has no moving parts capable of breaking or becoming jammed. The present invention provides a device that may place a strap under tension simply by rotating the device in a first direction to place it in a secured position. The present invention may release the strap from the tension by rotating it in a second direction to place it in a released or unsecured position.

### RELATED APPLICATIONS

This application claims priority to provisional patent application 63/742,469 filed on Jan. 7, 2025.

### BACKGROUND OF THE INVENTION

### 1) Field of the Invention

The present invention relates to an improved tensioning device that may replace a traditional ratchet and in at least one embodiment contains no moving parts. The present invention greatly simplifies the process of placing and maintaining a tow or cargo strap under tension using a single integral piece that has no moving parts capable of breaking or becoming jammed.

### 2) Description of the Related Art

Ordinarily, ratchets have many moving parts that are used to either clamp or release a tow or cargo strap being placed under tension. Further, these ratchet devices require that a handle be cranked back and forth several times to tighten the straps. These devices ordinarily include a release mechanism that allows the strap to be loosened. Often these release mechanisms can be difficult to operate, making it difficult to release and/or loosen the strap. Not only can these prior art devices be difficult and time consuming to operate, but they also include many moving parts that are subject to becoming jammed or otherwise inoperable.

Therefore, one objective of the present invention is to provide an improved tensioning device that has no moving parts. Another object of the present invention is to provide a device that does not require repeated cranking of a handle or lever to place a strap under tension. It is another object of the present invention to provide a device that may place a strap under tension simply by rotating the device a single time in a first direction. It is another object of the present invention to provide a device that may release the strap from the tension by rotating the device a single time in a second direction.

### BRIEF SUMMARY OF THE INVENTION

The above objectives are accomplished by providing a tensioning device comprising: central body member having a first side and a second side; a first strap torquing member and a second strap torquing member, each being disposed at a first end of the central body member and extending perpendicularly from the first side of the central body member, wherein the second torquing member is laterally spaced from the first torquing member; a strap securing member that is disposed on a second, opposite end of the central body member and extending perpendicularly from the first side of the central body member so that the strap securing member is longitudinally spaced from the first and the second strap torquing members and is laterally spaced so that the strap securing member is located between the first second strap torquing members; a handle that is disposed at the second end of the central body member and extends outwardly from the central body member.

In at least one embodiment, the first strap torquing member is adapted to engage a first surface of a first portion of a strap that has been folded over itself and the second strap torquing member is adapted to engage at second side of the first portion of the strap. In at least one embodiment, the strap securing member is adapted to engage the folded portion of the strap at the first side of the strap.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a perspective view of an embodiment of the present invention.

FIG. 2 is a perspective view of an embodiment of the present invention.

FIG. 3 is a perspective view of an embodiment of the present invention while engaging a strap.

FIG. 4 is a perspective view of an embodiment of the present invention during use.

FIG. 5 is a side elevation view showing the second surface of the present invention.

### DETAILED DESCRIPTION OF THE INVENTION

With reference to the drawings, the invention will now be described in more detail.

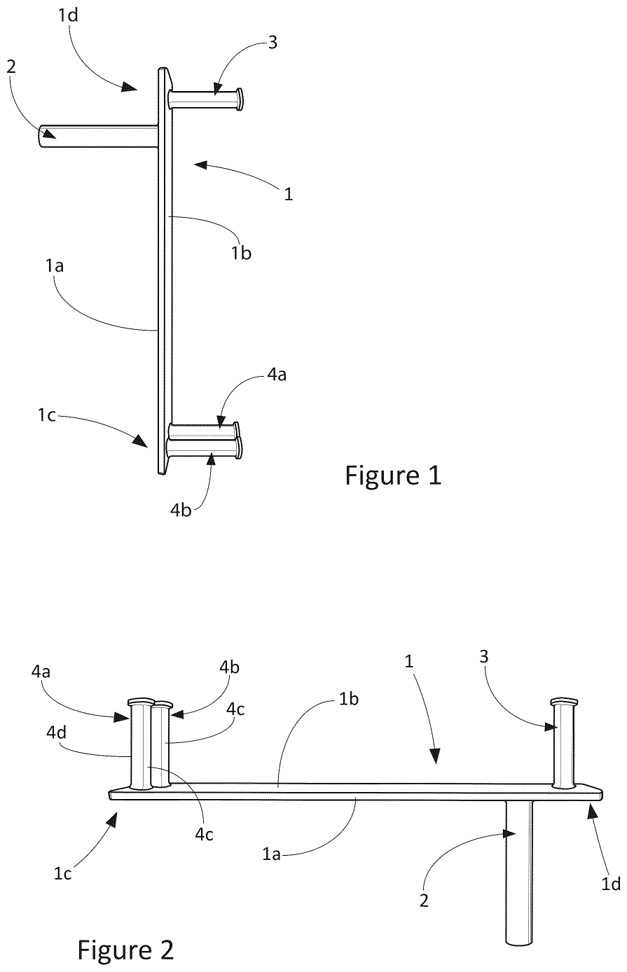

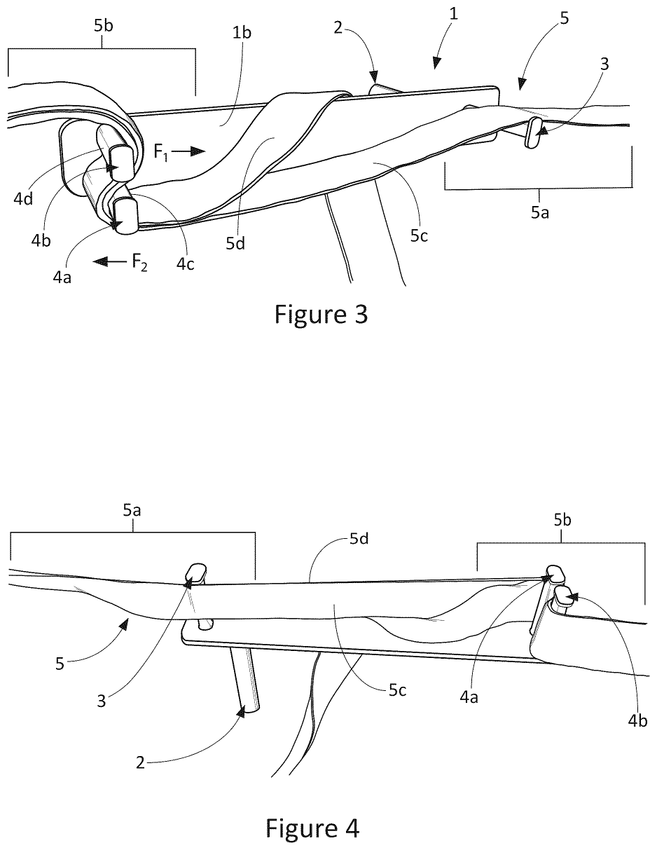

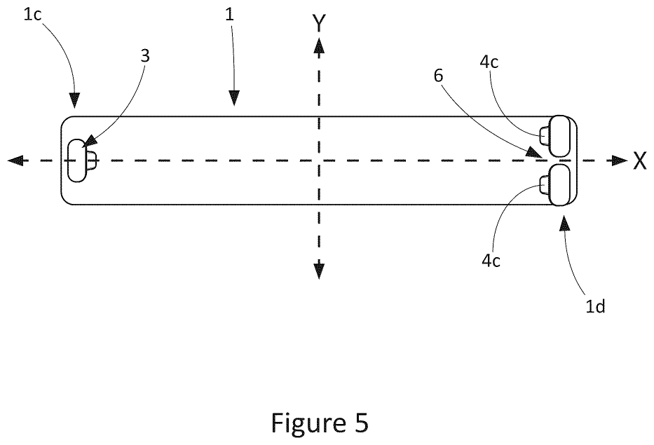

Referring to FIGS. 1-2, an improved tensioning device is shown. In the shown embodiment, the device includes a central body member 1, a first surface 1b and a second surface 1a, each having a longitudinal axis (shown as X in FIG. 3 and FIG. 5) extending along a length and a latitudinal axis (shown as Y in FIG. 3 and FIG. 5) extending along the width, where the longitudinal axis extends a greater distance than the latitudinal axis. The device further includes a first strap torquing member 4a and a second strap torquing member, which are disposed at a first end portion 1c of the central body member 1. The first and second strap torquing members 4a-b extend from the first surface 1b in a generally perpendicular manner. In at least one embodiment, the strap torquing members extend from the first surface such that they are perpendicular to the first surface, in other embodiments, they extend from the first surface at an angle that is either obtuse or acute angle. In the shown embodiment, the strap torquing members are integrally affixed to the central body member. In alternate embodiments, they could be pivotally connected to the central body member 1 so that when not in use, the strap torquing members could be folded to lay substantially flat against the first surface 1b. Alternatively, the strap torquing members 4a-b could be removably attached to the central body member 1. The strap torquing members are laterally spaced along the width of the central body member creating a strap insertion space into which a strap may be inserted. This strap insertion space may be seen at reference number 6 in FIG. 3. In one embodiment the strap torquing members are equidistant from the longitudinal axis X. In alternate embodiments their distances from the longitudinal axis may be different from one another.

The present invention further includes a strap securing member 3 that is disposed on the first surface 1b of a second end portion 1d of the central body member. In one embodiment the strap securing member 3 forms a right angle with the first surface 1b while in alternate embodiments the strap securing member 3 forms one of an obtuse and an acute angle with the first surface 1b. The second end portion 1d is opposite of the first end portion 1c of the central body member so that the strap securing member 3 is longitudinally spaced from the strap torquing members 4a-b. The strap securing member is positioned on the first surface 1b at a point that is longitudinally spaced from but laterally spaced within the strap securing space 6 such that if line segments were drawn to connect each of the strap torquing members 4a-b and the strap securing member 3, the line segments connecting the strap torquing members 4a-b and the strap securing member 3 would form a triangle having no right angles. In one embodiment, the strap securing member 3 is laterally spaced so that it is disposed on the longitudinal axis X and is longitudinally spaced from the midpoint between the strap torquing members. In alternate embodiments, however, the strap securing member could be laterally spaced from the longitudinal axis so that its distance from the longitudinal axis X is the same as the distance between the longitudinal axis and the first torquing member 4a. In such an embodiment, the strap securing member 3 would line up with the first strap torquing member 4a such that if line segments were drawn connecting the two strap torquing members 4a-b and the strap securing member 3, a right triangle would be formed. This strap securing member 3 may be integrally affixed to the central body member or it may be hingedly connected so that when not in use it may lay substantially flat against the central body member. In another embodiment, the strap securing member could be removably connected to the central body member. In at least one embodiment, the first and second strap torquing members 4a-b are equidistant from the latitudinal axis Y of the central body member. In at least one embodiment, the strap securing member 3, and both of the strap torquing members 4a-b are all equidistant to the latitudinal axis Y of the central body member.

In the shown embodiment, the present invention further includes a handle 2 that extends perpendicularly from a second surface 1a of the central body member 1. The handle may be disposed at the second end portion 1d of the central body member. The handle may be integrally affixed to the central body member or it may be hingedly connected thereto so that when it is not in use it may lay substantially flat against the central body member. In another embodiment, the handle could be removably attached to the central body member. In alternate embodiments, the handle 2 could extend from the end of the central body member so that it extends outwardly in direction that is generally parallel to the first surface 1b and second surface 1a of the central body member.

Referring now to FIGS. 3-4, the device may be seen in use. A cargo strap 5 having a front side 5c and a back side 5d may be secured to a first securing point (not shown) on a vehicle or other structure to which the strap may be connected by a hook, clamp or other securing member (not shown) that is disposed on a first section 5a of the strap. The strap 5 may be secured to a second securing point (not shown) on a vehicle or other structure by looping a second section 5b of the strap through the securing point. Once looped through the securing point, the strap's second portion 5b may be folded over itself so that the strap's front side touches itself, thus creating a second folded section 5b of the strap as well as a first unfolded section 5a of the strap. The device may then be positioned such that (a) the two torquing members 4a-b are adjacent to the second folded section of the strap 5b and are generally perpendicular to the strap and (b) the central body member 1 is in a first direction so that the second end 1d of the central body member is facing a first direction in which the strap securing member 3 is adjacent to the folded section 5b of the strap and is closer than the torquing members 4a-b to the folding point of the strap's folded section (and thus the securing point through which the strap's folded section is looped). Once the device is in the correct position, the folded section 5b of the strap may be inserted into the strap insertion space 6 defined by the two torquing members 4a-4b. Once the strap's folded section 5b is inserted into the strap insertion space 6, the tensioning device is in the unsecured position where the strap is not being held under tension by the strap torquing members 4a-4b.

Once in the unsecured position, the central body portion 1 may be rotated so that the second end 1d of the central body portion 1 moves towards the first unfolded section 5a of the strap so that the central body portion is placed into and faces a second direction where the strap securing member 3 is farther than the torquing members 4a-b from the folding point of the strap's second folded section 5b (and thus closer to the strap's first unfolded section 5a). The handle 2 may be used to aid in the rotation of the central body portion from the first direction into the second direction. The greater the distance between the handle 2 and the torquing members, the greater the leverage will be when rotating the central body portion. Once the central body member is rotated into the second direction, it may be placed in a secured position (shown in FIG. 4) by placing the strap securing member 3 behind the first section of the strap 5a so that the securing member 3 engages the back side of the strap 5d. The securing member 3 ensures that the device remains in the secured position so that the strap is maintained under tension while the device is in the secured position.

When placing the central body member 1 into the secured position by rotating the central body portion in the second direction, the first torquing member 4a will engage the front side of the strap's folded section 5b. However, because the second section of the strap is folded over itself, the first torquing member is actually engaging the back side 5d of the strap. When the central body member is rotated, the second torquing member 4b will engage the opposite side of the strap's folded section 5b. Again, because the strap is folded over itself, the second torquing member will also engage the back side 5d of the strap. By rotating the central body portion, the strap's folded portion is placed in a “S” shaped configuration, where the folded section of the strap 5b will be engaged by a first surface 4c of the second torquing member 4b as well as a second surface 4d of the first torquing member. In this manner the first torquing member 4a will exert a first force F1 on the strap in a first direction and the second torquing member 4b will exert a second force F2 in a second, opposite direction, thus placing the strap under tension, which may be maintained until the device is placed in the unsecured position, where the securing member 3 is disengaged from the back side 5b of the strap that is located in the first unfolded section 5a and the device is rotated back towards the first direction where the securing member is placed closer to the strap's second folded section 5b.

The amount of tension that is placed on the strap when the device is in the secured position is determined by how much slack is allowed in the strap when the device is in the unsecured position. If the strap is pulled tightly between the two securing points, a great deal of tension will be created by placing the device in the secured position. Conversely, if the strap is loosely connected between the two securing points, little to no tension will be created by placing the device in the secured position. The initial tightness of the strap can be adjusted by how tightly the strap is pulled between the two securing points before the strap is folded over itself to create the folded portion 5b. If the strap is too tight, it is possible that the device may not be able to be rotated in the second direction so as to place it in the secured position. In such an instance, the user may simply provide more slack in the strap before placing the device in the secured position.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A tensioning device comprising:
a central body member having a first side and a second side;
a first strap torquing member and a second strap torquing member, each being disposed at a first end of the central body member and extending outwardly from the first side of the central body member, wherein the second strap torquing member is laterally spaced from the first strap torquing member, thus defining a strap insertion space;
a strap securing member that is disposed on a second end of the central body member that is opposite of the first end, wherein the strap securing member extends perpendicularly from the first side of the central body member so that the strap securing member is longitudinally spaced from the first strap torquing member and the second strap torquing member and is laterally spaced so that the strap securing member is below the first strap torquing member and above the second strap torquing member;
a handle that is disposed on the second end of the central body member and extends outwardly from the central body member.

2. The device of claim 1 wherein, the first strap torquing member and the second strap torquing member are adapted to engage a first section of a strap having a first side and a second side and that that has been folded over itself so that a first portion of the first side of the strap is adjacent to a second portion of the first side of the strap, wherein each of the first strap torquing member and the second strap torquing member are adapted to engage the second side the strap when the first section of the strap is placed in the strap insertion space.

3. The device of claim 2 wherein both the first strap torquing member and the second strap torquing member have a first surface and a second surface and wherein the tensioning device has a secured position wherein, the first section of the strap is engaged by both the first surface of the first strap torquing member and the second surface of the second strap torquing member and a second portion of the is engaged by the strap securing member.

4. The device of claim 1 wherein the tensioning device has a secured position and an unsecured position, wherein the device is placed in a secured position by facing the central body portion in a first position, inserting the first section of the strap into the strap insertion space, rotating the central body portion in a second direction and causing the strap securing member to engage a second section of the strap and wherein the tensioning device may be placed in an unsecured position by causing the strap securing member to disengage the second section of the strap and rotating the central body member towards the first direction.

5. The device of claim 1 wherein the strap has a first side and a second side and the tensioning device has a secured position wherein each of the strap securing member, the first strap torquing member and the second strap torquing member engage the second side of the strap.

6. The device of claim 1 wherein the first strap torquing member and the second strap torquing member are equidistant from a longitudinal axis of the central body member.

7. The device of claim 1 wherein the strap securing member is disposed on a longitudinal axis of the central body member.

8. The device of claim 1 wherein the first strap torquing member and the strap securing member are equidistant from a latitudinal axis of the central body member.

9. The device of claim 1 wherein the handle is disposed on the second side of the central body member.

10. A tensioning device comprising:
a central body member having a first side and a second side;
a first strap torquing member and a second strap torquing member, each being disposed on a first end of the central body member and each having a first surface and a second surface and wherein the second strap torquing member is laterally spaced from the first strap torquing member, thus defining a strap insertion space into which at least a portion of a strap may be inserted;
a strap securing member that is disposed on a second end of the central body member that is opposite of the first end; and
wherein the tensioning device has a secured position wherein, a first section of the strap is engaged by both the first surface of the first strap torquing member and the second surface of the second strap torquing member and a second portion of the strap is engaged by the strap securing member.

11. The device of claim 1 wherein when the tensioning device has an unsecured position where the second end of the central body portion faces a first direction and the first section of the strap is located within the strap insertion space, and wherein when in the tensioning device is in the secured position, the second end of the central body portion faces a second direction that is opposite the first direction.

12. The device of claim 1 wherein, the first section of the strap comprises a first folded section of the strap where a first portion of a first side of the strap is adjacent to a second portion of the first side of the strap, and wherein when the tensioning device is in the secured position, each of the first strap torquing member, the second strap torquing member and the strap securing member engage the second side the strap, thereby maintaining the strap under tension.

13. The device of claim 1 further comprising a handle that is disposed on the second end of the central body member and extends outwardly from the central body member.

14. The device of claim 13 each of the first strap torquing member, second torquing member and strap securing member are disposed on the first side of the central body portion and the handle is disposed on the second side of the central body portion.

15. The device of claim 1 wherein the first strap torquing member and the second strap torquing member are equidistant from a longitudinal axis of the central body member.

16. The device of claim 1 wherein the strap securing member is disposed on a longitudinal axis of the central body member.

17. The device of claim 1 wherein the first strap torquing member and the strap securing member are equidistant from a latitudinal axis of the central body member.

18. The device of claim 1 where each of the first strap torquing member, second torquing member and strap securing member are hingedly connected to the central body portion.

19. A tensioning device comprising:
a central body member having a first side and a second side;
a first strap torquing member and a second strap torquing member, each being disposed on the first side of the central body member and defining a strap insertion space between the first strap torquing member and the second strap torquing member into which a strap may be inserted;
a strap securing member disposed on the first side of the central body member;
wherein the tensioning device has an unsecured position where a first end of the central body member faces a first direction and a first section of the strap is located in the strap insertion space; and
wherein the tensioning device has a secured position where the first end of the central body member faces a second direction that is opposite the first direction and where the first strap torquing member and the second torquing member engage a first section of the strap and the strap securing member engages a second section of the strap, thereby maintaining the strap under tension.

20. The device of claim 19 wherein each of each of the first strap torquing member and the second torquing member have a first surface and a second surface and wherein when the tensioning device is in the secured position, the first surface of the first strap torquing device and the second surface of the second strap torquing member engage a first side of the strap.
